(19) United States
(12) Patent Application Publication
(10) Pub. No.: US 2023/0418657 A1
(43) Pub. Date: Dec. 28, 2023

(54) RUNTIME PREDICTION FOR JOB MANAGEMENT

(71) Applicant: BMC Software, Inc., Houston, TX (US)

(72) Inventor: Nikolai OZEROV, Richmond Hill (CA)

(21) Appl. No.: 17/809,486

(22) Filed: Jun. 28, 2022

(51) Int. Cl. G06F 9/48; G06N 5/02

(52) U.S. Cl. CPC G06F 9/4818; G06N 5/02

(57) ABSTRACT

Described techniques provide optimized job management with accurate runtime predictions for individual job instances. By classifying jobs with respect to combinations of multiple prediction algorithms and multiple job properties, including classifying different job instances of a single job, the described techniques enable use of fast, simple prediction techniques while still providing accurate predictions.

### TECHNICAL FIELD

This description relates to job management using runtime prediction.

### BACKGROUND

Job management in the context of computing systems may include scheduling multiple job instances for execution, in a manner that optimizes for some aspect of the execution being performed. For example, job management may include attempting to ensure that a set of job instances are completed by a certain deadline, or that higher priority jobs are completed before lower priority jobs.

Effective job management may be difficult or impossible, however, when a runtime of a job instance to be executed is not accurately predicted prior to initiation of the execution of the job instance. For example, a job instance that takes considerably longer than a predicted runtime to complete may delay execution of a subsequent job(s), which may ultimately result in a violation of a service level agreement, or some other undesirable outcome.

### SUMMARY

According to some general aspects, a computer program product may be tangibly embodied on a non-transitory computer-readable storage medium and may include instructions. When executed by at least one computing device, the instructions may be configured to cause the at least one computing device to classify a job of a plurality of completed jobs executed by an operating system, the job having a corresponding plurality of job instances, as having a runtime that is not predictable within a first prediction threshold of a first prediction algorithm or within a second prediction threshold of a second prediction algorithm of a plurality of prediction algorithms. When executed by the at least one computing device, the instructions may be configured to cause the at least one computing device to perform a segmentation of the job instances into first job instances and second job instances using at least one segmentation threshold that defines the first job instances as having runtimes predicted within the first prediction threshold when using the first prediction algorithm or the second prediction threshold when using the second prediction algorithm. When executed by the at least one computing device, the instructions may be configured to cause the at least one computing device to select the first prediction algorithm, based on the segmentation, receive a new job instance of the job, predict a predicted runtime of the new job instance, using the first prediction algorithm, and submit the new job instance to the operating system for execution thereof, based on the predicted runtime.

According to other general aspects, a computer-implemented method may perform the instructions of the computer program product. According to other general aspects, a system, such as a mainframe system or a distributed server system, may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for runtime prediction for job management.

FIG. 2 is a block diagram illustrating a first example job instance segmentation that may be performed using the system of FIG. 1.

FIG. 3 is a block diagram illustrating a second example job instance segmentation that may be performed using the system of FIG. 1.

FIG. 4 is a flowchart illustrating example operations of the system of FIG. 1.

FIG. 5 is a flowchart illustrating more detailed example job instance evaluation and segmentation process of the system of FIG. 1, as illustrated in FIG. 2.

FIG. 6 is a flowchart illustrating more detailed example job instance evaluation and segmentation process of the system of FIG. 1, as illustrated in FIG. 3.

FIG. 7 is a flowchart illustrating an example job management process, using the evaluation and segmentation processes of FIGS. 1-6.

### DETAILED DESCRIPTION

Described systems and techniques enable, for example, optimized job management with accurate runtime predictions for individual job instances. By classifying jobs with respect to combinations of multiple prediction algorithms and multiple job properties, including classifying different job instances of a single job, the described techniques enable use of fast, simple prediction techniques while still providing accurate predictions. Alternative solutions, in contrast, may either use more complex prediction techniques, and/or may use simple prediction techniques but obtain unacceptable prediction results.

The following example descriptions are provided in the context of mainframe systems. In mainframe systems, centralized processing is provided for, and linked to, many different workstations or terminals, e.g., in a corporate environment. For example, such mainframe systems may provide core functionalities in healthcare, insurance, banking and finance, energy and oil and gas, manufacturing, or industrial settings, may store and process vast amounts of data for millions of customers, and may have been in use for multiple decades.

In a mainframe environment, many different applications may leverage a central mainframe operating system (OS) to perform various tasks, or jobs. For example, multiple applications may continuously require jobs to be performed by a mainframe OS, so that it becomes necessary to schedule a coordinated execution of the various jobs by the mainframe OS.

In the present description, a job therefore refers to and includes a set of instructions to be applied by a mainframe OS, or other OS or computing system, against corresponding, related data. For example, an application may perform various transactions during a day, and then a batch job may perform processing of related transaction data for many such transactions (e.g., to generate a report related to the transactions).

Therefore, a job instance refers to a particular execution of a job. A specific job instance may therefore differ in various aspects from other job instances of a same, single job. For example, continuing the above examples, a job instance performed with respect to transactions conducted on a very busy day may take longer than a job instance of the same job performed on a weekend or holiday. Similarly, a job instance performed in one system context may take longer than in another system context, even when the data being processed in both systems is very similar.

Described techniques use multiple prediction algorithms, classify different jobs and job instances with respect to the multiple prediction algorithms, and segment job instances of a single job into two or more groups when needed to ensure compatibility with at least one of the prediction algorithms. In this way, when new job instances of various jobs are received, the future runtimes of the various job instances may be accurately predicted, and an overall job schedule may be maintained to within desired service levels.

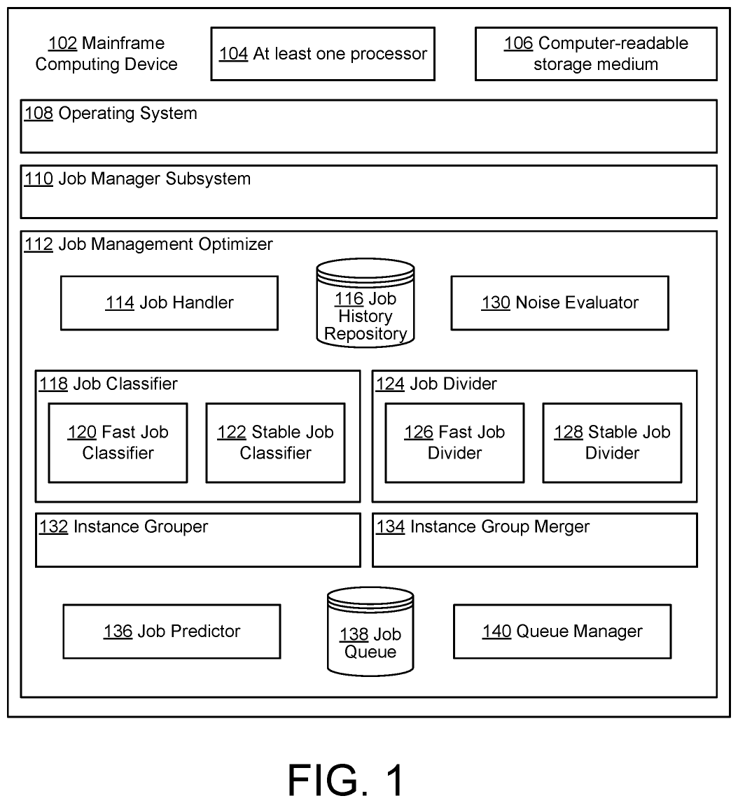

FIG. 1 is a block diagram of a system for runtime prediction for job management. In FIG. 1, a mainframe computing device 102, which may be referred to herein as a mainframe computer or mainframe, refers to any computer, or combination of computers in communication with one another, that is or are used to implement the types of mainframe applications and associated jobs referenced above, including the more specific examples provided below.

The mainframe 102 may be deployed by a business owner or organization, e.g., to support business functions. The mainframe 102 may support many different workstations or peripheral devices, or otherwise provide access and business functions to employees, administrators, customers, or other users.

The mainframe 102 is illustrated as including at least one processor 104 and non-transitory computer-readable storage medium 106. As the mainframe 102 supports business-critical functions for many (e.g., millions) of users, the at least one processor 104 may be understood to represent many different processors (e.g., some of which may be included as part of the mainframe 102 and some of which may be included outside of the mainframe 102 but within a mainframe computing environment of the mainframe 102) providing significant quantities of processing power. Similarly, the non-transitory computer-readable storage medium 106 represents large quantities of various types of memory (e.g., registers, main memory, or bulk/secondary memory) that may be used to store instructions executable by the at least one processor 104, as well as to store data (e.g., business data, including customer data).

In addition to providing large quantities of processing and memory resources, the mainframe 102 should be understood to provide many other features and advantages, some of which are described herein by way of example. To assist in providing these features and advantages, an operating system (OS) 108 may be configured to, and optimized for, characteristics and functions of the mainframe 102. The OS 108 may, for example, provide task scheduling, application execution, and peripheral control. Put another way, the OS 108 enables use of the at least one processor 104 and the computer-readable storage medium 106 across many different use cases of the mainframe 102.

The OS 108 may represent or include a suite or collection of system tools and services designed to support operations of the mainframe computing device 102. In many cases, such tools and services may evolve over time, and new tools and services may be added as they are developed. For example, the OS 108 may represent the z/OS® operating system, and may include, or utilize, a multiple virtual storage (MVS) system. In other examples, not specifically illustrated in FIG. 1, the OS 108 may use a z/OS Unix® system.

A job manager subsystem 110 represents a system, such as a subsystem, designed to facilitate and enable executions of jobs, e.g., using the MVS system, or, more generally, the OS 108. For example, the job manager subsystem 110 may be configured to identify and provide needed system resources to execute a requested job. In example implementations, some of which are described below, the job manager subsystem 110 may represent the Job Entry Subsystem (JES) of IBM, or different versions thereof, such as JES2 or JES3.

Further in FIG. 1, a job management optimizer 112 may be configured to interact with the job manager subsystem 110 and/or the OS 108 to increase or enhance a throughput of jobs that will run in the OS 108. For example, the job management optimizer 112 may be configured to determine required resources for each job to be processed, to ensure efficient processing.

As referenced above, and described in detail, below, the job management optimizer 112 may also be configured to predict a runtime of each job instance to be executed using the OS 108, e.g., an elapsed time between job start and job completion. It is possible to use an average job runtime across all instances for each job that is to be submitted, but such simplistic approaches may result in violations of service level agreements or other undesirable outcomes.

In FIG. 1, however, the job management optimizer 112 includes a job handler 114 that may be configured to interact with a job history repository 116 that stores historical job data for many completed jobs. As described below, the job history repository 116 may store many completed job instances for a corresponding plurality of jobs, along with corresponding execution data, related metadata, job profile information, and other job properties.

For example, a single job may be executed during testing, quality assurance (QA), and production contexts, and each corresponding job instance may have different job properties. More generally, as referenced above, job instances of a job may be run on different days, or on different systems, or at different times of a single day. Consequently, the job history repository 116 may store a job instance along with the system on which it was executed, a time/day of execution, and a total elapsed runtime required for completion.

The job handler 114 may be configured to access the job history repository 116, e.g., at periodic or defined intervals, to analyze the included job history data and parameterize future prediction operations for predicting runtimes of new job instances to be executed. As described below, the job handler 114 may initially filter some sets of jobs or job instances that do not have sufficient numbers of samples to be processed using the described techniques.

Then, a job classifier 118 may be configured to attempt to classify jobs and corresponding job instances from the job handler 114. For example, a fast job classifier 120 may be configured to attempt to classify a job and its job instances as jobs that are completed within a pre-defined time limit, referred to herein as the fast time limit.

That is, the fast time limit refers to a maximum quantity of time, of relatively brief duration, required for runtime of corresponding jobs or job instances. When jobs are relatively quick or brief in this context, then it may be possible to predict corresponding future job instances as having runtimes in accordance with the fast time limit.

For example, the fast time limit may be set to two minutes. Then, corresponding future job instances may be predicted based on a fraction or other multiple of the fast time limit. For example, corresponding future job instances may be predicted to have a runtime of 50% of the fast time limit, e.g., a runtime of one minute.

Of course, the above are just examples, and any suitable fast time limit may be used. In general, when job instances of a job have been completed quickly, variations across the job instances may be relatively small (relative to a desired or necessary level of prediction precision). In such cases, an easy-to-calculate approximation (e.g., a simple fraction) of the fast time limit may be sufficiently accurate.

A stable job classifier 122 may be configured to classify jobs and job instances that may be classified based on having relatively low levels of variation with respect to one another, even if an overall runtime of each or all such jobs or job instances is beyond the fast time limit. For example, as described in detail, below, stability of a job in this context may be characterized based on a deviation-to-mean ratio of deviation of runtimes of job instances of the job to an average or mean value of runtimes of job instances of the job. When job instances of a job are classified as stable by the stable job classifier 122, it may be possible to predict future runtimes of corresponding job instances (i.e., job instances of the same job being analyzed) using, e.g., the calculated average of the job instance runtimes.

In many cases, however, the fast job classifier 120 and the stable job classifier 122 may determine that a specific job (and corresponding job instances) do not meet the criteria for either a fast job prediction algorithm or a stable job prediction algorithm. In these cases, a job divider 124 may be configured to segment the job instances of the job being analyzed into two segments or subsets of job instances, e.g., first job instances and second job instances.

For example, a fast job divider 126 may segment job instances based on a segmentation threshold defined in terms of the fast time limit. For example, first job instances may include job instances having a runtime(s) less than the fast time limit, while second job instances may include job instances having a runtime(s) more than the fast time limit.

In another example, a stable job divider 128 may segment job instances based on a segmentation threshold defined as an adaptive binarization threshold. For example, the Otsu segmentation algorithm, traditionally used for image segmentation as discussed below, may be used to define the first job instances and the second job instances.

A noise evaluator 130 may be configured to evaluate the second job instances to determine whether the second job instances may be considered to be noise for purposes of job instance runtime prediction. In the present description, noise refers to job instance samples that disrupt (e.g., make unreliable) a corresponding prediction algorithm.

For example, as described above, the fast job divider 126 may segment job instances into first job instances having a runtime(s) less than the fast time limit, and second job instances having a runtime(s) more than the fast time limit. Then, the second job instances may be considered to be noise, in that their inclusion within the job instances as a whole disrupts, or is inconsistent with, use of the fast job prediction algorithm. Put another way, application of the fast job prediction algorithm to the second job instances would result in an incorrect runtime prediction for those job instances.

Similarly with respect to the stable job divider 128, the stable job divider 128 segments job instances into first job instances that can accurately be predicted using the stable job prediction algorithm, and second job instances that cannot accurately be predicted using the stable job prediction algorithm. Then, the second job instances may be considered to be noise in that their inclusion within the job instances as a whole disrupts, or is inconsistent with, use of the stable job prediction algorithm. Put another way, application of the stable job prediction algorithm to the second job instances would result in an incorrect runtime prediction for those job instances.

The noise evaluator 130 is thus configured to determine whether the second job instances are within a noise threshold with respect to operations of the fast job prediction algorithm or the stable job prediction algorithm. For example, if a total count of the second job instances and/or a ratio of second job instances to first job instances are below a noise threshold(s) for results of the fast job divider 126, then the noise evaluator 130 may determine that the fast job prediction algorithm may be used with respect to the first job instances, and therefore with respect to future job instances of the job in question. Similarly, if the second job instances are below a noise threshold(s) for results of the stable job divider 128, then the noise evaluator 130 may determine that the stable job prediction algorithm may be used with respect to the first job instances, and therefore with respect to future job instances of the job in question.

In some cases, neither the fast job prediction algorithm nor the stable job prediction algorithm may be usable for a job (and its corresponding job instances) being analyzed. In these cases, an instance grouper 132 may be configured to group the job instances based on one or more job instance properties of the job instances. Then, each resulting job instance group may be processed by the job divider 124 and the noise evaluator 130, as already described above.

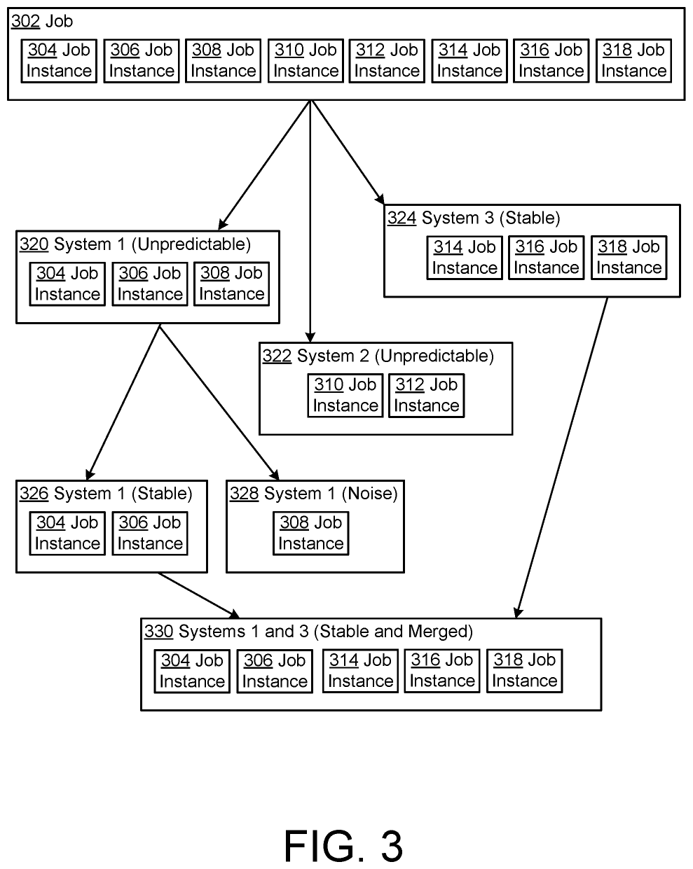

Accordingly, it may occur that at least one resulting job instance group may be determined to be predictable, e.g., using either the fast job prediction algorithm or the stable job prediction algorithm. For example, as described in detail below with respect to FIG. 3, job instances of a job may be grouped based on the systems with which they were executed. A job instance group associated with a particular system may be determined to be predictable using the fast job prediction algorithm (or the stable job prediction algorithm). Then, future job instances that are both instances of the same job and executed using the same system may have their runtimes predicted using the fast job prediction algorithm (or the stable job prediction algorithm).

In some cases, job instances of a single job may be grouped into multiple groups. For example, there may be three or more systems used to execute the job instances. Then, an instance group merger 134 may be configured to merge two or more of the job instance groups, e.g., prior to processing by the job divider 124 and the noise evaluator 130.

In this way, larger groups may be formed through merging operations, resulting in groups that may be more amenable to the types of statistical processing described herein. Future job instances may be allocated for corresponding predictions when the future job instances have at least one of the job instance properties of the merged group(s).

The job history repository 116, or other suitable storage, may be used to store relationships between one or more prediction algorithms and corresponding jobs, job instances, and/or groups of job instances. For example, a particular job may be related to the fast job prediction algorithm or the stable job prediction algorithm.

In other examples, a particular group of job instances of a particular job may be related to the fast job prediction algorithm or the stable job prediction algorithm. For example, as just described, such a job instance group may be defined with respect to one or more job instance properties, such as system of execution, day of the week of execution, and/or time of day of execution.

Then, when a new, current job instance is received at the job handler 114, a job predictor 136 may be configured to analyze the new job instance and predict its runtime once it is submitted to the OS 108 for execution. For example, the job predictor 136 may map the job instance to its corresponding job, and thus to a particular job prediction algorithm. If the new job instance does not map to a particular prediction algorithm, the job predictor 136 may use one or more job instance properties of the new job instance to map the new job instance to a previously classified job instance group, and thereby to a specific job prediction algorithm.

The job predictor 136 may perform such job predictions for a plurality of job instances, and a job queue 138 may be managed by a queue manager 140 to order and arrange the new job instances for submission to the OS 108 (e.g., via the job manager subsystem 110). The queue manager 140 may use various queue management techniques to order the received, predicted job instances. For example, the queue manager 140 may utilize a job completion deadline, time periods required for predicted job instances, a type or extent of system resources required for the predicted job instances, and/or priority levels assigned to the various job instances.

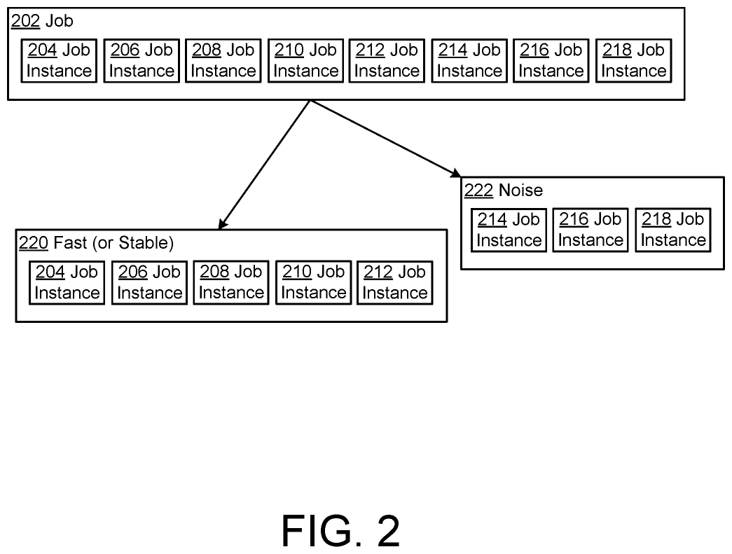

FIG. 2 is a block diagram illustrating a first example job instance segmentation that may be performed using the system of FIG. 1. In FIG. 2, a job 202 may be stored in the job history repository 116, along with various completed job instances 204, 206, 208, 210, 212, 214, 216, 218. It will be appreciated that typical use cases may have far more than the eight job instances illustrated in FIG. 2. That is, the example of FIG. 2 may be understood to represent a highly simplified example for the purposes of illustration and explanation, and the specific numbers of job instances discussed should not be considered either limiting or representative. Similar comments apply to FIG. 3.

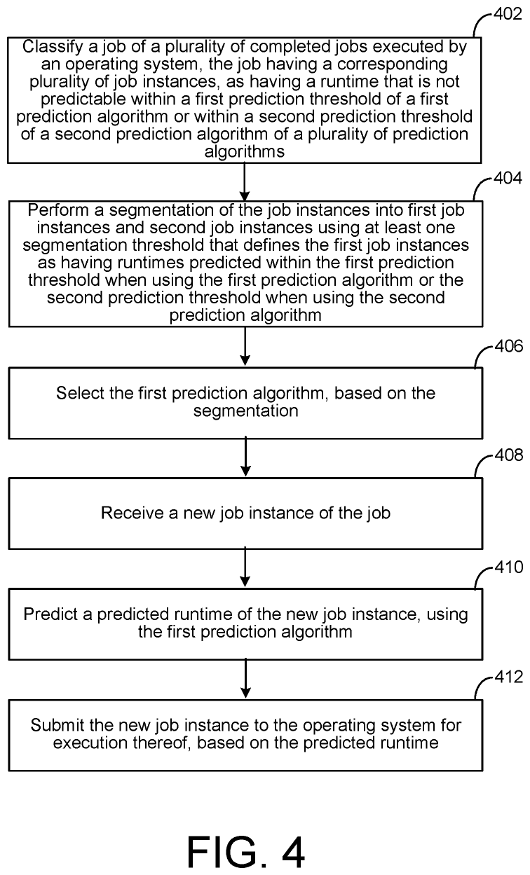

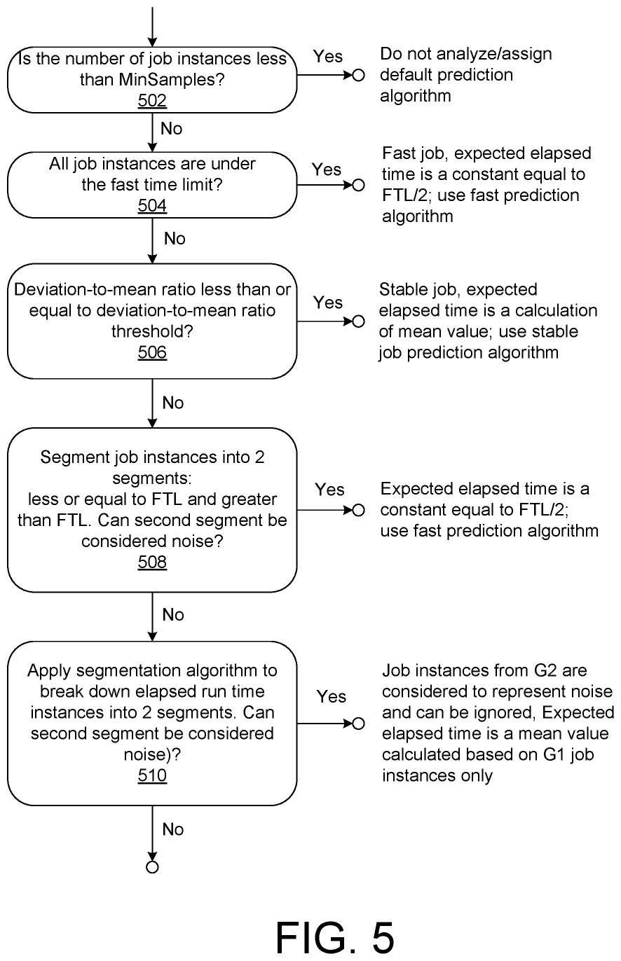

In FIG. 2, the job classifier 118 may determine that neither the fast job prediction algorithm nor the stable job prediction algorithm may be used for predicting future job instances of the job 202, as referenced above and described in more detail below, e.g., with respect to FIGS. 4 and 5. Then, the job divider 124 may segment the job instances 204-218 into a first segment 220 that is compatible with the fast (or stable) job prediction algorithm, and a second segment 222 that is not compatible with the fast (or stable) job prediction algorithm.

The noise evaluator 130 may determine whether the segment 222 qualifies as noise. If so, then future job instances of the job 220 may be classified as being predictable by the fast (or stable) job prediction algorithm. If not, then analysis may proceed by the instance grouper 132, as referenced above and described in more detail below, e.g., with respect to FIGS. 3, 4, and 6.

For example, FIG. 3 is a block diagram illustrating a second example job instance segmentation that may be performed using the system of FIG. 1. In the example of FIG. 3, a job 302 includes job instances 304, 306, 308, 310, 312, 314, 316, and 318.

In FIG. 3, similarly to FIG. 2, the job classifier 118 may determine that neither the fast job prediction algorithm nor the stable job prediction algorithm may be used for predicting future job instances of the job 302. Then, the job divider 124 may segment the job instances 304-318 into a first segment 320 (including job instances 304, 306, 308) that is not compatible with the fast (or stable) job prediction algorithm, a second segment 322 (including job instances 310, 312) that is not compatible with the fast (or stable) job prediction algorithm, and a third segment 324 (including job instances 314, 316, 18) that is compatible with the stable job prediction algorithm. For example, as shown, the job divider 124 may segment the job instances of FIG. 3 based on job instances performed by different hypothetical systems referenced as system 1 for the job instance segment 320, system 2 for the job instance segment 322, and system 3 for the job instance segment 324.

Then, the processes of the job classifier 118, the job divider 124, and the noise evaluator 130 may be repeated for each segment of job instances. For example, the job classifier 118 and the job divider 124 may process the job segment 320 in the same manner as described above with respect to the job 202 of FIG. 2, to determine that the segment 320 includes a further segment 326 (with job instances 304, 306) that can be accurately predicted using the stable job prediction algorithm, and a further segment 328 (with job instance 308) that qualifies as noise. Meanwhile, the job classifier 118 (e.g., the stable job classifier 122) may determine that the segment 324 may be accurately predicted using the stable job prediction algorithm, without requiring further job instance division or segmentation.

The job classifier 118, the job divider 124, and or the noise evaluator 130 may determine that the segment 322 cannot be accurately predicted using either the fast or the stable job prediction. For example, the job divider 124 may determine that there is no suitable basis for further segmentation. Or, even if a further segmentation is available, the noise evaluator 130 may determine that neither of the resulting further segmentations qualifies as noise. In other examples, it may occur that a segmentation such as the segmentation 322 does not have a sufficient number of included job instances to be statistically meaningful for job instance prediction analysis.

Further in FIG. 3, the instance group merger 134 may proceed to merge the job instance segment 326 and the job instance segment 324, to obtain a job instance group 330. As shown, the job instance group 330 thus includes job instances 304, 306, 314, 316, and 318.

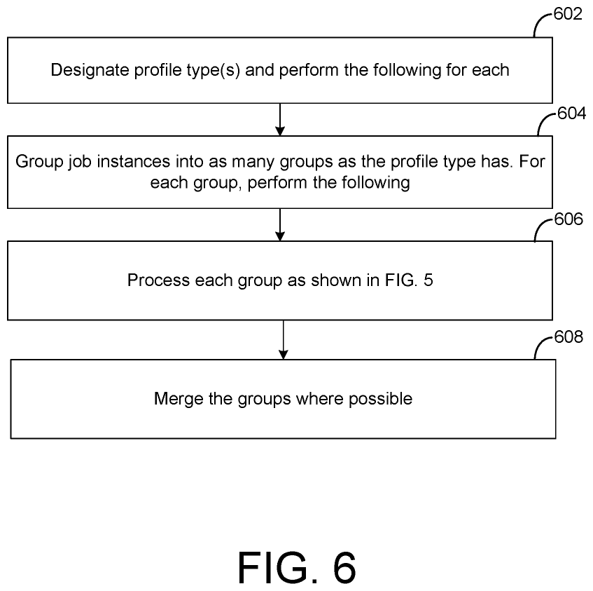

Consequently, the job predictor 136 may later receive a job instance of the job 302. If the received job instance is to be executed on either system 1 or system 3, the job predictor 136 may proceed to use the stable job prediction algorithm to predict a runtime of the received job instance, for use by the queue manager 140 in managing the queue 138. If, however, the received job instance is to be executed on system 2, then the job predictor 136 may use alternative techniques to enable the queue manager 140 to manage the job queue 138, as described below with respect to FIG. 6.

In some scenarios, it may occur that an incoming job instance may be correlated with a suitable system(s) as described, but that system(s) may not be available for that job instance at a time of execution of the job instance. In such scenarios, the job instance may be assigned to an available system, and the runtime may be predicted using a default technique.

FIG. 4 is a flowchart illustrating example operations of the system of FIG. 1. In the example of FIG. 4, operations 402-412 are illustrated as separate, sequential operations. In various implementations, the operations 402-412 may include sub-operations, may be performed in a different order, may include alternative or additional operations, or may omit one or more operations. Further, in all such implementations, included operations may be performed in an iterative, looped, nested, or branched fashion.

In the example flow chart of FIG. 4, a job of a plurality of completed jobs executed by an operating system, the job having a corresponding plurality of job instances, may be classified as having a runtime that is not predictable within a first prediction threshold of a first prediction algorithm or within a second prediction threshold of a second prediction algorithm of a plurality of prediction algorithms (402). For example, the job classifier 118 (e.g., the fast job classifier 120) may classify the job 202 as not being predictable within the fast time limit as the first prediction threshold. Additionally, the job classifier 118 (e.g., the stable job classifier 122) may classify the job 202 as not being predictable within a defined value or threshold of a deviation-to-mean ratio defined using a ratio of deviation to mean of average job instance runtimes of the job instances. Other job prediction algorithms, and corresponding prediction thresholds, may be used.

A segmentation of the job instances into first job instances and second job instances may be performed using at least one segmentation threshold that defines the first job instances as having runtimes predicted within the first prediction threshold when using the first prediction algorithm or the second prediction threshold when using the second prediction algorithm (404). For example, the job divider 124 (e.g., the fast job divider 126) may define the first job instances as being within the fast time limit and the second job instances as not being within the fast time limit. Additionally, the job divider 124 (e.g., the stable job divider 128) may define the first job instances as being within the deviation-to-mean ratio threshold and the second job instances as not being within the deviation-to-mean ratio threshold. For example, in FIG. 2, the job instances 220 may represent the first job instances and the job instances 222 may represent the second job instances.

The first prediction algorithm may be selected, based on the segmentation (406). For example, the noise evaluator 130 may determine that the second job instances (e.g., the job instances 222 in FIG. 2) qualify as noise for purposes of classifying the first job instances. In the present example, the first prediction algorithm may be considered to be either the fast job prediction algorithm, the stable job prediction algorithm, or any suitable algorithm being used as one of the plurality of prediction algorithms.

Although not described explicitly with respect to FIG. 4, it will be appreciated that the grouping operations of the instance grouper 132 and the merging operations of the instance group merger 134 may also be included in example implementations. For example, the job instances 304-318 of FIG. 3 may be grouped into groups or segments 320, 322, 324, based on relevant job instance properties. Then, operations 402-406 may be repeated with respect to one or more of the job instance groups, e.g., to obtain first job instances 326 and second job instances 328. In the example, the first job instances 326 may be determined to be predictable within a deviation-to-mean ratio threshold and the stable prediction algorithm may be selected. As also shown and described, the job instances 326 may be merged with the job instances 324 by the instance group merger 134 to result in job instances 330.

A new job instance of the job may be received (408). For example, the job handler 114 and/or the job predictor 136 may receive a new job instance to be executed by the OS 108. The job predictor 136 may map the new job instance to its corresponding job and associated job prediction algorithm, using a job instance property if needed.

A predicted runtime of the new job instance may be predicted, using the first prediction algorithm (410). For example, the job predictor 136 may predict the elapsed runtime of the job instance, using the stable job prediction algorithm (or the fast job prediction algorithm).

The new job instance may then be submitted to the operating system for execution, based on the predicted runtime (412). For example, the queue manager 140 may insert the job instance into the job queue 138 for submission to the OS 108 (e.g., via the job manager subsystem 110).

FIG. 5 is a flowchart illustrating more detailed example job instance evaluation and segmentation process of the system of FIG. 1, as illustrated in FIG. 2. In the example of FIG. 5, and as described above, it is assumed that actual starting and ending job times have been collected in the job history repository 116, along with various other job properties (e.g., a system on which the job instance(s) ran).

The resulting job history data for each job may be assessed periodically to determine whether there is sufficient information (e.g., number of samples/job instances) to re-calculate job prediction statistics. When these re-calculations begin, the re-calculations may be performed using all instances collected for the job being analyzed, with a goal (as described above) of assigning a prediction category either to all instances of the job, or to break down the job instances into profile groups based on job properties, so that a prediction category may be assigned to one or more of the resulting groups. In the following examples, categories for which it is determined to be possible to calculate a predicted runtime using a corresponding job prediction algorithm(s) may be referred to as ‘green’ categories, while remaining categories may be referred to as ‘red’ categories.

Thus, in FIG. 5, if a number of job instances of the job being analyzed is less than a minimum (‘MinSamples’) (502), then the analysis may not proceed further. In such cases, for example, if a new job instance of the job in question were received, then a default prediction algorithm may be used. The default prediction algorithm may include the fast prediction algorithm, the stable job prediction algorithm, or some other suitable prediction algorithm.

Otherwise, if all of the job instances are within the fast time limit (504), then the job may be classified as a fast job and the fast prediction algorithm may be used. For example, the expected elapsed runtime may be predicted to be a constant equal to the fast time limit divided by two (or other suitable constant value).

If all of the job instances are within the deviation-to-mean ratio that is less than or equal to a deviation-to-mean ratio threshold (506), then the job may be classified as a stable job for which an expected elapsed runtime may be calculated as a mean value of the job instance runtimes. For example, the stable job classifier 122 may first calculate a standard deviation of the runtimes of the various job instances as well as an average of the runtimes of the various job instances, to thereby determine the deviation-to-mean ratio for the job instances in question.

Otherwise, the job instances may be segmented into first job instances with runtimes less than or equal to the fast time limit, and second job instances with runtimes greater than the fast time limit (508). If the second segment of job instances may be considered to be noise, then the job may be classified as a fast job and the fast prediction algorithm may be used. For example, the expected elapsed runtime may be predicted to be a constant equal to the fast time limit divided by two (or other suitable constant value).

For example, the first job instances may be referred to as G1 and the second job instances may be referred to as G2, so that |G1| refers to a count of instances in G1 and |G2| refers to a count of instances in G2. Then example noise criteria may include, e.g., |G2| being less than a maximum noise count (NoiseMaxCount), and/or |G2|/|G1|*100% being less than a maximum percentage (MaxNoiseRate).

For example, in a specific example, noise criteria may include [(|G2| <NoiseMaxCount AND |G2|/|G1|*100%<MaxNoiseRate) OR (|G2|/|G1|*100%<NoiseExtremeRate), where NoiseExtremeRate is a smaller percentage than MaxNoiseRate. For example, a deviation-to-mean ratio threshold may be set within 30% and 70%, e.g., 45% or 50%. MaxNoiseRate may be considered to be between, e.g., 10 and 25%, e.g., 15% or 20%. NoiseExtremeRate may be considered to be between, e.g., 0.2% and 3%, e.g., 0.5% or 1%. NoiseMaxCount may be defined as, e.g., fewer than 10 to 20 counts, e.g., 3 counts. Of course, all of the preceding examples are not limiting and are merely for example, and may be adjusted based on various factors, such as total number of job instance samples and/or desired levels of prediction accuracy.

Otherwise, the segmentation algorithm may be used to break down the elapsed run time instances into 2 segments (510), i.e., the job instances may be segmented into first job instances with deviation-to-mean ratios less than or equal to the deviation-to-mean ratio threshold, and second job instances with deviation-to-mean ratios greater than the deviation-to-mean ratio threshold. If the second segment of job instances may be considered to be noise, then the job may be classified as a stable job and the stable prediction algorithm may be used (510). For example, the expected elapsed runtime may be predicted to be an average value of the job instance runtimes of the first job instances. Additionally, or alternatively, a segmentation algorithm such as the Otsu algorithm may be used, as referenced above. Otherwise, the process proceeds to FIG. 6.

With respect to FIG. 5, it may be observed that the processing proceeds from simpler and fewer categories and associated calculations to more complex categories and calculations. Consequently, processing may be performed in an efficient, effective manner.

FIG. 6 is a flowchart illustrating more detailed example job instance evaluation and segmentation process of the system of FIG. 1, as illustrated in FIG. 3. In FIG. 6, profile types may be designated to initiate the execution (602). For example, as described above, profile types may include day of the week of execution, time of the day of execution, or system of execution.

The job instances may then be grouped into as many groups as the profile type has (604). For example, the profile type for day of the week may have seven groups. A system profile type may have a number of types corresponding to a number of systems used. Time of day profile groups may be defined hourly or within other defined time periods.

Then, each job instance group may be processed using the techniques of FIG. 5 (606). Therefore, each job instance group may be classified, divided, or otherwise designated with respect to available prediction algorithms, as described above. If a particular group cannot be assigned any prediction algorithm, then any included job instances may be designated for prediction using a default prediction algorithm.

Groups may be merged where possible (608). For example, merging may be performed when the resulting group may be predicted using one of the available prediction algorithms. In this way, more job instances may be processed, and prediction quality may be improved by increasing a number of samples in a (merged) group.

For example, groups may be merged when the resulting merged group would have a predicted runtime that is within a merger threshold for predicted runtimes of the individual groups. For example, a group of Saturday job instances may have a first predicted (e.g., average) runtime, and a group of Sunday job instances may have a second predicted (e.g., average) runtime. If the two runtimes are within a defined quantity of time as one another, then the two groups may be merged. Similar comments apply to other types of job instance groupings.

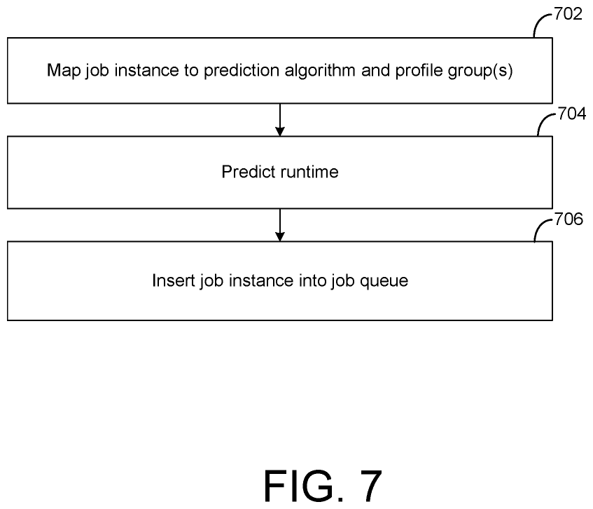

FIG. 7 is a flowchart illustrating an example job management process, using the evaluation and segmentation processes of FIGS. 1-6. In the example of FIG. 7, a newly received job instance to be executed is mapped to a corresponding prediction algorithm and profile group(s) (702). For example, when a new job instance is received for execution, the relevant, previously calculated statistics may be looked up. If the job was assigned a ‘green’ category, so that a known predicted runtime may be predicted, the corresponding runtime may be predicted (704). If no category was assigned to the job but the job has multiple profile groups, the properties of the new job instance may be used to determine whether it belongs to a profile group associated with a ‘green’ category. If so, a known predicted runtime may be predicted, and the corresponding predicted runtime may be used. If no ‘green’ category is available for the job, a default prediction algorithm may be used, such as taking a mean value of the available job instance samples as a predicted runtime.

It is possible that a search for a profile group based on certain job properties may have more than one successful match. As an example, a group for a specific day of week and a group for running on a specific system may be found, and both may have available prediction algorithm(s) and associated predicted runtime(s).

In such cases additional verification may be needed. For example, both groups may have a mean runtime that is sufficiently close to be considered compatible. Otherwise, the default prediction may be used.

Then, the job instance may be inserted into the job queue based on the runtime prediction (706). For example, job instances within the job queue 138 may be reordered as needed to meet an expected service level agreement or other deadline. Or, if the predicted runtime indicates that the job instance cannot be completed by such a deadline, then the job instance may be held for later execution.

As referenced above, many products make use of the collected job elapsed runtime historical data, but in practice, only a small fraction of jobs may have a statistically well-defined distribution of elapsed time values suitable to support a predicted runtime. A single job may have significantly different elapsed time values based on many external properties, such as a system the job is executing on, day of the week or month the job is executing (e.g., a run at the end of the month may produce a monthly summary, deal with a larger set of data, and takes a relatively longer time), day of week (e.g., weekend job runs may be quicker if they deal with lower activity during the weekend as compared to weekdays), and so on. As a result, a job may have significantly different sets of job runs that constitute different job profiles.

Described techniques enable detection of job profiles based on collected historical data for a job, and mapping of a new job instance to a corresponding profile. Accordingly, simple prediction algorithms may be used to provide a high precision expected elapsed time value for the coming job instance run, and such precise expected elapsed times will increase an efficacy of the job management optimizer 112.

Although the above description primarily deals with predictions of elapsed runtimes, similar concepts could be used to predict other job properties. For example, described techniques may be used to select one system over another, or to select one day of the week over another for a preferred job run(s).

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, a server, a mainframe computer, multiple computers, or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
classify a job of a plurality of completed jobs executed by an operating system, the job having a corresponding plurality of job instances, as having a runtime that is not predictable within a first prediction threshold of a first prediction algorithm or within a second prediction threshold of a second prediction algorithm of a plurality of prediction algorithms;
perform a segmentation of the job instances into first job instances and second job instances using at least one segmentation threshold that defines the first job instances as having runtimes predicted within the first prediction threshold when using the first prediction algorithm or the second prediction threshold when using the second prediction algorithm;
select the first prediction algorithm, based on the segmentation;
receive a new job instance of the job;
predict a predicted runtime of the new job instance, using the first prediction algorithm; and
submit the new job instance to the operating system for execution thereof, based on the predicted runtime.

2. The computer program product of claim 1, wherein the first prediction algorithm includes a fast job prediction algorithm for predicting job instance runtimes based on a fast time limit, and the first prediction threshold is based on the fast time limit.

3. The computer program product of claim 2, wherein the segmentation threshold is based on the fast time limit, and the first job instances have runtimes within the fast time limit.

4. The computer program product of claim 1, wherein the first prediction algorithm includes a stable job prediction algorithm for predicting job instance runtimes based on an average, and the first prediction threshold is based on a deviation-to-mean ratio threshold.

5. The computer program product of claim 4, wherein the segmentation threshold is determined using an adaptive binarization threshold, and the first job instances have an average runtime within the first prediction threshold.

6. The computer program product of claim 4, wherein the stable job prediction algorithm predicts the predicted runtime of the new job instance using an average value of the first job instances.

7. The computer program product of claim 1, wherein the instructions are further configured to cause the at least one computing device to:
define the plurality of job instances as a first group of job instances having a first job property, the job having a second group of job instances having a second job property.

8. The computer program product of claim 7, wherein the instructions are further configured to cause the at least one computing device to:
determine, when receiving the new job instance, that the new job instance has the first job property; and
select the first prediction algorithm for predicting the predicted runtime, based on the new job property having the first job property.

9. The computer program product of claim 1, wherein the instructions are further configured to cause the at least one computing device to:
classify the second job instances as noise with respect to the first prediction algorithm.

10. The computer program product of claim 1, wherein the instructions are further configured to cause the at least one computing device to:
insert the new job instance into a job queue of job instances to be submitted to the operating system.

11. A computer-implemented method, the method comprising:
classifying a job of a plurality of completed jobs executed by an operating system, the job having a corresponding plurality of job instances, as having a runtime that is not predictable within a first prediction threshold of a first prediction algorithm or within a second prediction threshold of a second prediction algorithm of a plurality of prediction algorithms;
performing a segmentation of the job instances into first job instances and second job instances using at least one segmentation threshold that defines the first job instances as having runtimes predicted within the first prediction threshold when using the first prediction algorithm or the second prediction threshold when using the second prediction algorithm;
selecting the first prediction algorithm, based on the segmentation;
receiving a new job instance of the job;
predicting a predicted runtime of the new job instance, using the first prediction algorithm; and
submitting the new job instance to the operating system for execution thereof, based on the predicted runtime.

12. The method of claim 11, wherein the first prediction algorithm includes a fast job prediction algorithm for predicting job instance runtimes based on a fast time limit, and the first prediction threshold is based on the fast time limit.

13. The method of claim 12, wherein the segmentation threshold is based on the fast time limit, and the first job instances have runtimes within the fast time limit.

14. The method of claim 11, wherein the first prediction algorithm includes a stable job prediction algorithm for predicting job instance runtimes based on an average, and the first prediction threshold is based on a deviation-to-mean ratio threshold.

15. The method of claim 14, wherein the segmentation threshold is determined using an adaptive binarization threshold, and the first job instances have an average runtime within the first prediction threshold.

16. The method of claim 11, further comprising:
defining the plurality of job instances as a first group of job instances having a first job property, the job having a second group of job instances having a second job property;
determining, when receiving the new job instance, that the new job instance has the first job property; and
selecting the first prediction algorithm for predicting the predicted runtime, based on the new job property having the first job property.

17. The method of claim 11, further comprising:
classifying the second job instances as noise with respect to the first prediction algorithm.

18. A mainframe system comprising:
at least one memory including instructions; and
at least one processor that is operably coupled to the at least one memory and that is arranged and configured to execute instructions that, when executed, cause the at least one processor to
classify a job of a plurality of completed jobs executed by an operating system, the job having a corresponding plurality of job instances, as having a runtime that is not predictable within a first prediction threshold of a first prediction algorithm or within a second prediction threshold of a second prediction algorithm of a plurality of prediction algorithms;
perform a segmentation of the job instances into first job instances and second job instances using at least one segmentation threshold that defines the first job instances as having runtimes predicted within the first prediction threshold when using the first prediction algorithm or the second prediction threshold when using the second prediction algorithm;
select the first prediction algorithm, based on the segmentation;
receive a new job instance of the job;
predict a predicted runtime of the new job instance, using the first prediction algorithm; and
submit the new job instance to the operating system for execution thereof, based on the predicted runtime.

19. The system of claim 18, wherein the instructions are further configured to cause the at least one processor to:
define the plurality of job instances as a first group of job instances having a first job property, the job having a second group of job instances having a second job property;
determine, when receiving the new job instance, that the new job instance has the first job property; and
select the first prediction algorithm for predicting the predicted runtime, based on the new job property having the first job property.

20. The system of claim 18, wherein the instructions are further configured to cause the at least one processor to:
classify the second job instances as noise with respect to the first prediction algorithm.
